(19) United States
(12) Patent Application Publication
(10) Pub. No.: US 2011/0173550 A1
(43) Pub. Date: Jul. 14, 2011

(54) DATA DRIVEN USER INTERFACE ANIMATION

(75) Inventor: Kenneth G. Oetzel, Belmont, CA (US)

(73) Assignee: MICROSOFT CORPORATION, Redmond, WA (US)

(21) Appl. No.: 12/687,092

(22) Filed: Jan. 13, 2010

(51) Int. Cl. G06F 3/048

(52) U.S. Cl. 715/757; 715/765

(57) ABSTRACT

A data driven method of animating a user interface includes managing a virtual variable with a cloud computing device. The method further includes, in response to receiving user input at the cloud computing device, using a physics engine of the cloud computing device to update a value of the virtual variable. The method further includes receiving UI data at the cloud computing device from one or more remote content providers, wherein the UI data defines one or more user interface objects and how the one or more user interface objects are to be displayed by the cloud computing device as a function of the virtual variable. The method further includes outputting display instructions for displaying the one or more user interface objects in accordance with the UI data and the value of the virtual variable as the value of the virtual variable is updated by the physics engine.

### BACKGROUND

The conventional approach to declarative animation for interactive user interfaces is to use events to trigger time-based animations. Each animation or collection of animations is scripted on a timeline and triggered when an event such as a click or a keypress occurs. With this approach, it is possible to develop an interface with a rich set of behaviors. However, because each state transition has a unique animation, either the number of animations will be large or the number of state transitions will be limited. As such, conventional declarative animation may not be well suited for all applications.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Various embodiments related to data driven user interface animation are discussed herein. One disclosed embodiment includes a data driven method of animating a user interface, which includes managing a virtual variable with a cloud computing device. The method further includes, in response to receiving user input at the cloud computing device, using a physics engine of the cloud computing device to update a value of the virtual variable. The method further includes receiving UI data at the cloud computing device from one or more remote content providers, wherein the UI data defines one or more user interface objects and how the one or more user interface objects are to be displayed by the cloud computing device as a function of the virtual variable. The method further includes outputting display instructions for displaying the one or more user interface objects in accordance with the UI data and the value of the virtual variable as the value of the virtual variable is updated by the physics engine.

### BRIEF DESCRIPTION OF THE DRAWINGS

FIG. 1 shows an example cloud computing device performing data driven user interface animations in accordance with an embodiment of the present disclosure.

FIG. 2 schematically shows the cloud computing device of FIG. 1.

FIGS. 3 & 4 show time sequences demonstrating the dynamic updating of the virtual position of a virtual puck.

FIG. 5A schematically shows exemplary parameter data.

FIG. 5B shows a graphical representation of the parameter data of FIG. 5A.

FIG. 5C shows a time sequence demonstrating the dynamic updating of the virtual position of a virtual puck in accordance with the parameter data of FIG. 5A.

FIG. 5D shows how a display parameter of a user interface object is changed as a function of the changing position of the virtual puck of FIG. 5C.

FIG. 6 shows an example data driven method of animating a user interface in accordance with an embodiment of the present disclosure.

FIG. 7 shows an example method of animating a list in accordance with an embodiment of the present disclosure.

### DETAILED DESCRIPTION

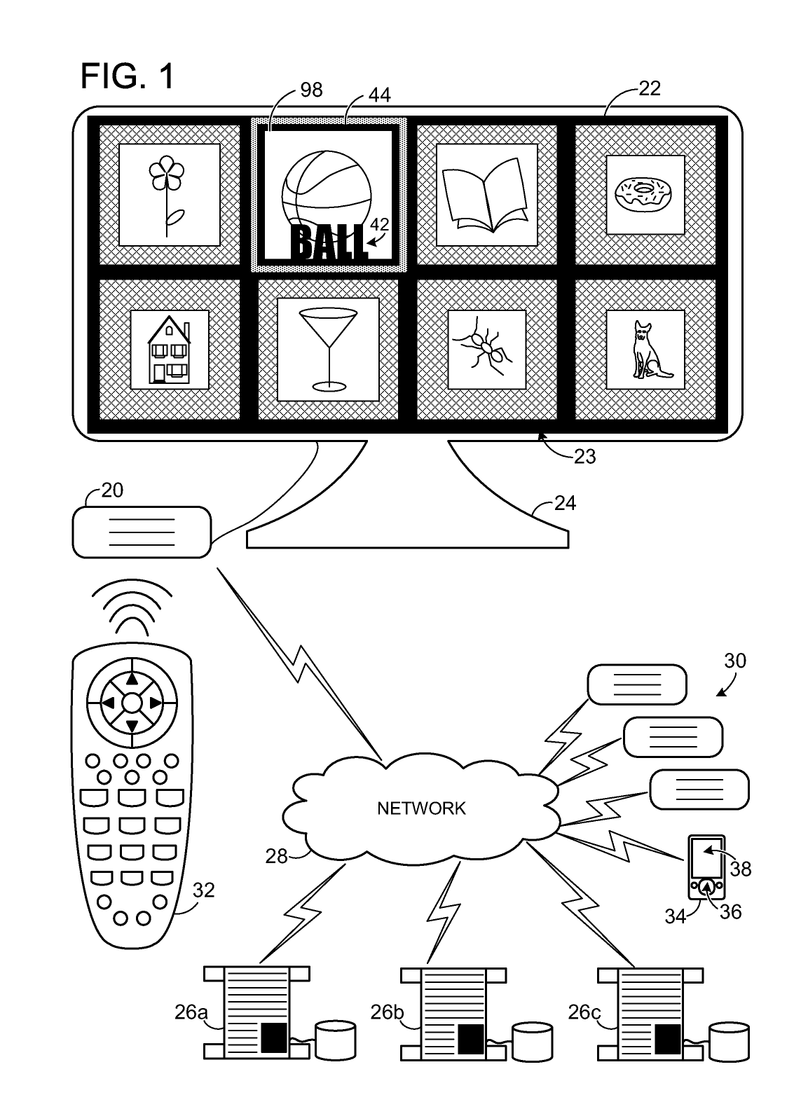

FIG. 1 shows a cloud computing device 20 for displaying remotely served content. As an example, cloud computing device 20 is displaying a digital photo album 22 on a high definition television 24. Cloud computing device 20 is configured to receive content for display from one or more content providers (e.g., content provider server 26a, content provider server 26b, and/or content provider server 26c) via one or more networks 28 (e.g., the Internet).

The present disclosure describes a data driven mechanism that allows content providers to customize the look and feel of content that is displayed by the cloud computing device 20. The ultimate look and feel of the content can be controlled by the content provider without writing executable code such as user interface programs and/or scripts. As discussed below, content providers can define seemingly complicated user interface animations with simple non-executable data, such as extensible markup language (XML) data. Furthermore, the user interface animations defined by the non-executable data are highly responsive, allowing interruptions and/or modifications to a running animation anytime user input is detected. As such, content providers may provide visually appealing and responsive experiences to users while avoiding the time consuming and difficult process of writing user interface programs and/or scripts. Furthermore, using the below described data driven mechanism, a content provider may easily change the content that is being provided (e.g., which digital photographs are being served) and/or the animations used to display the content (e.g., zooms, fades, etc.).

While FIG. 1 is described primarily with reference to cloud computing device 20 and an example digital photo album, it is to be understood that virtually any networkable computing device may be configured to display virtually any type of remotely served content. Furthermore, two or more different cloud computing devices may be configured to display the same remotely served content. As an example, cloud computing devices 30 may be configured to display the photo album 22 or other remotely served content. Content providers may provide different non-executable data to different cloud computing devices so that each device can display the same content in a manner that is tailored to that device's capabilities (e.g., screen size and/or screen resolution).

Different cloud computing devices may be configured to receive user input via a variety of different user input devices. As an example, FIG. 1 shows a wireless remote control 32 that is configured to send user interface control commands to cloud computing device 20. Remote controls are well suited for controlling ten-foot user interfaces displayed on televisions, such as high definition television 24. Nonetheless, it is to be understood that the present disclosure is compatible with key pads, touch pads, key boards, motion sensors, vision-based skeletal trackers, and other user input devices. As another example, a mobile cloud computing device 34 may include a keypad 36 and/or a touch screen 38.

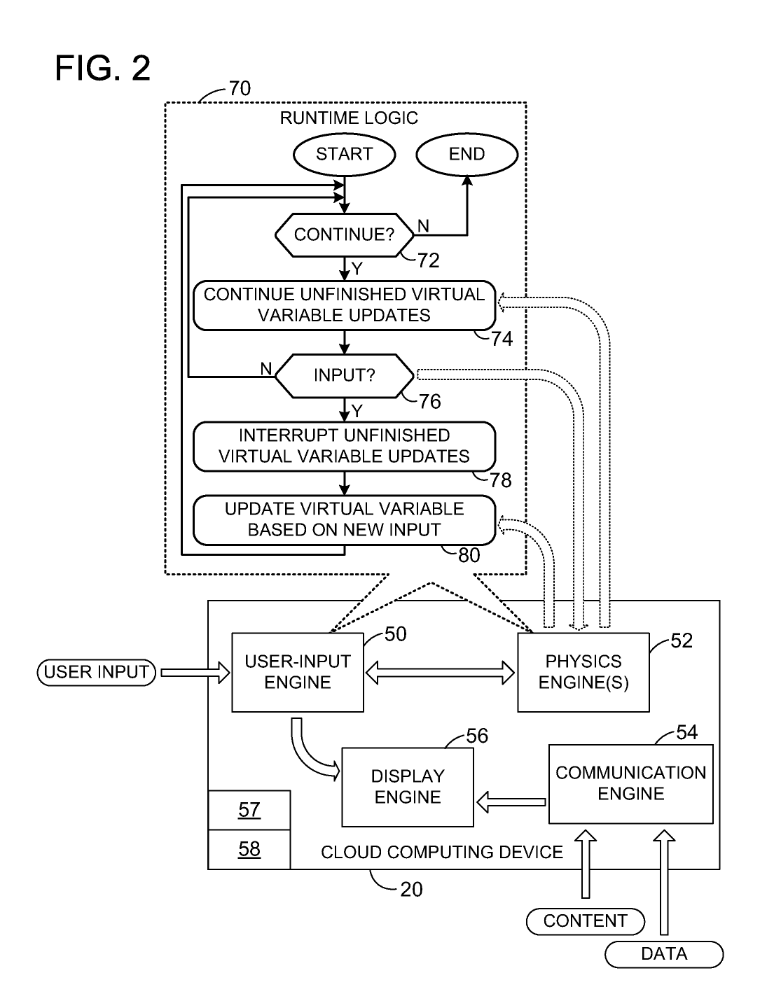

FIG. 2 somewhat schematically shows a cloud computing device 20 in accordance with an embodiment of the present disclosure. Cloud computing device 20 includes a user-input engine 50, a physics engine 52, a communication engine 54, and a display engine 56.

User-input engine 50 is configured to receive user interface control commands from a user input device, such as remote control 32 of FIG. 1. User-input engine 50 may include one or more different busses, receivers, radios, ports, controllers, and/or other mechanisms to accommodate communication with a desired type of user input device. As a nonlimiting example, when configured for use with a remote control, user-input engine 50 may include an IR receiver, an RF receiver, and/or an IEEE 802.15x receiver.

The physics engine 52 is configured to dynamically update a virtual value of one or more virtual variables responsive to user interface control commands received via the user-input engine 50. As a nonlimiting example, the physics engine may be configured to dynamically update a virtual position of a virtual puck, where the virtual position of the virtual puck can be described by two virtual variables—a horizontal screen coordinate of the virtual puck and a vertical screen coordinate of the virtual puck. As described below, user interface objects may be functionally bound to one or more virtual variables so that the visual appearances of the user interface objects change as a stateless function of the virtual variables.

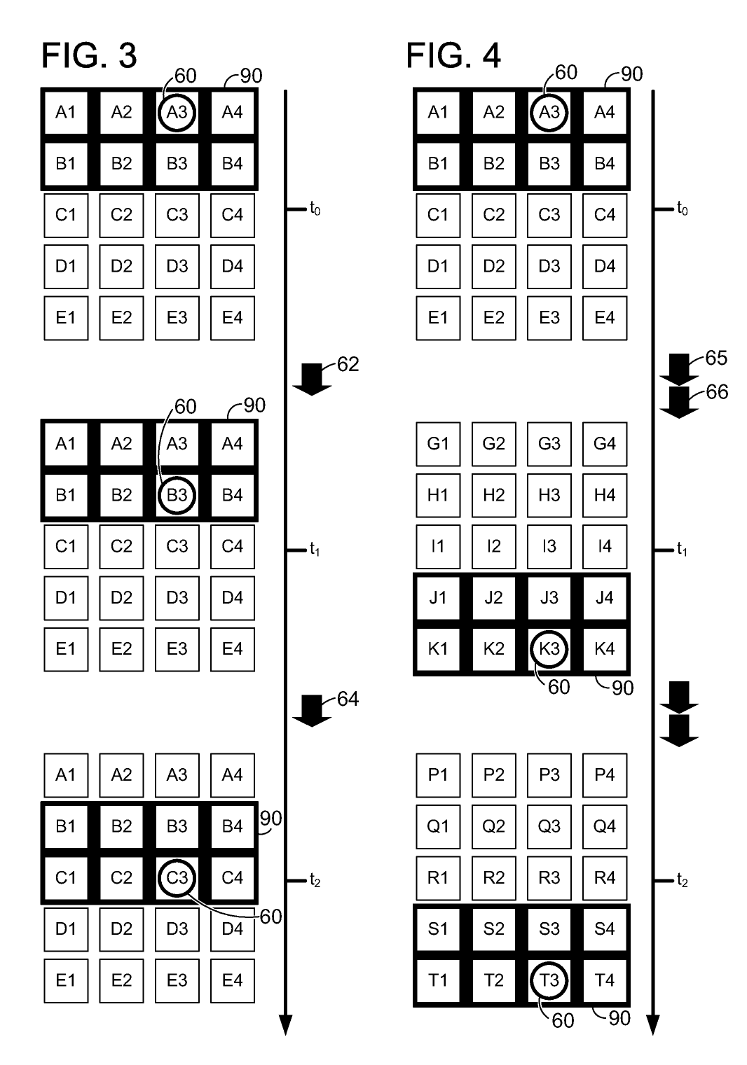

FIG. 3 shows a time sequence demonstrating how user interface control commands can be used to dynamically update the virtual position of a virtual puck 60, as defined by virtual vertical and horizontal coordinate variables. In FIG. 3, a matrix of cells are arranged in alphabetically ascending rows (i.e., row A, row B, row C, row D, etc.) and numerically ascending columns (i.e., column 1, column 2, column 3, and column 4). At time t₀, virtual puck 60 is located at cell A3. Between times t₀ and t₁, a down command 62 is received (e.g., responsive to a user pressing a down button on a remote control). In response to the down command, the physics engine of FIG. 2 may dynamically update the virtual position of the virtual puck. In this case, the virtual puck is moved down one row and is located at cell B3 at time t₁. Similarly, between times t₁ and t₂, a down command 64 is received and the virtual position of the virtual puck 60 is dynamically updated by the physics engine. In this case, the virtual puck is moved down another row and is located at cell C3 at time t₂.

The physics engine may be configured to dynamically update the virtual position of the virtual puck, or other virtual variables, using physics-based dynamics. The physics-based dynamics may consider virtual puck position, virtual puck velocity, virtual puck acceleration, and/or other kinematic-based parameters of the virtual puck.

As a simple example, a physics engine may virtually slide the virtual puck down one row during a given time period (e.g., t₁−t₀) in response to a single down command. The physics-based equations used to control movement of the virtual puck, or the value of another virtual variable, can be designed to produce a desired user interface experience. For example, conventional solutions to Newtonian second order differential equations can be used to control virtual puck movement, but with constraints so that a virtual puck always comes to rest at a cell and not between two adjacent cells. While FIG. 3 shows virtual puck 60 only at discrete cell locations A3, B3, and C3 at times t₀, t₁, and t₂ respectively, it is to be understood that the puck movement need not be in discrete chunks. To the contrary, the virtual puck may move continuously.

The physics engine may be configured to interrupt an unfinished update of the virtual position of the virtual puck if a subsequent user interface control command is received during the unfinished update. For example, if two down commands are given in rapid succession, as shown in FIG. 4, the second down command can effectively interrupt any unfinished updates resulting from the first down command. The physics engine may be configured to update the virtual position of the virtual puck responsive to subsequent user interface control commands that interrupt unfinished updates to the position of the virtual puck.

The input-time value of a virtual variable (i.e., the value of the virtual variable when the input is received) and an input-time first derivative of the virtual variable may be used as starting conditions for physics-based calculations performed by the physics engine. As such, two or more user interface control commands may produce different outcomes depending on the timing of the user interface control commands. For example, FIG. 3 shows an example where two down commands are temporally spaced far enough apart that down command 64 does not interrupt down command 62. The virtual puck 60 moves down two rows from A3 to C3 as a result of these two down commands. In contrast, FIG. 4 shows an example where two down commands are given in rapid succession, and down command 66 interrupts down command 65. The virtual puck 60 moves down ten rows from A3 to K3 as a result of these two down commands.

FIG. 2 shows example runtime logic 70 that can accommodate user input interrupts to dynamic physics-based updates. At 72, a flag or other controller can be used to specify whether updates are to be continued and/or whether user input is to be received. If not, the runtime logic ends. If so, flow proceeds to 74, where unfinished virtual variable updates, if any, are continued. At 76, if subsequent user input is not received, flow returns back to 72. If subsequent user input is received, flow proceeds to 78, where unfinished virtual variable updates, if any, are interrupted. At 80, the virtual variable is updated based on the new user input. The value of the virtual variable and/or the first derivative of the virtual variable at the time the unfinished update is interrupted may be used as starting conditions for the subsequent update. This interrupt ability allows a subsequent input to effectively cancel an update before it is completed and/or a subsequent input to cumulatively modify unfinished updates. Once a new update is started, flow returns to 72.

The physics engine may also be configured to dynamically update a virtual position of a virtual frame responsive to the virtual position of the virtual puck. As an example, FIGS. 3 and 4 show a virtual frame 90 in different positions. In the illustrated examples, the virtual puck effectively moves the virtual frame when the virtual puck moves to a cell past the borders of the virtual frame. As an example, in FIG. 3 virtual frame 90 moves down one row from time t₁ to time t₂, because the destination cell of the virtual puck, C3, is outside the bounds of virtual frame 90 at time t₁. As another example, in FIG. 4 virtual frame 90 moves down nine rows from time t₁ to time t₂, because the destination cell of the virtual puck, T3, is outside the bounds of virtual frame 90 at time t₁. As described below, the virtual frame may be used to determine what is displayed on a screen at any given time (e.g., which photos in a matrix of photos are displayed).

Turning back to FIG. 2, the communication engine 54 may be configured to receive non-executable data (UI data) from one or more content providers via one or more networks. Content providers can use the non-executable data to specify the content that is to be displayed by cloud computing devices as well as the manner in which the cloud computing devices display the content. As nonlimiting examples, content providers can use the non-executable data to specify zooms, fades, rotations, translations, color changes, font changes, and other effects that resemble conventional animations. However, unlike scripted animations, the non-executable data does not require the content provider to write animation scripts or other executable program code. Furthermore, unlike many scripted animations, the visual effects described herein are fully interruptible, thus providing a more responsive user experience.

The non-executable data defines user interface objects and how the user interface objects are to be displayed as a stateless function of the virtual position of the virtual puck, or other virtual variables. In some instances, user interface objects are defined by pointers that point to a network address (e.g., URL) where the interface object is saved. As an example, a user interface object may be a digital photograph saved on a remote server, and the non-executable data may include a pointer that points to the network location of the digital photograph so that it can be retrieved by cloud computing devices.

In some instances, user interface objects are defined by markup descriptions. The non-executable data may be XML data, as an example. In such cases, the cloud computing device may include an XML processing engine to translate the XML data for use by the physics engine and the display engine. As an example of a user interface object defined by markup descriptions, a user interface object may be a background rectangle to be placed behind a digital photograph, and the non-executable data may include markup specifying a size of the rectangle, a color of the rectangle, and a position of the rectangle.

It is to be understood that the above described digital photograph and rectangle are provided as nonlimiting examples of the virtually limitless number of different types of user interface objects that may be defined by non-executable data receivable by the communication engine.

Each user interface object defined by the non-executable data may include changeable parameters that control how aspects of the user interface object is to be displayed. Nonlimiting examples of changeable parameters include a position parameter for controlling where the user interface object is displayed, a size parameter for controlling the size of the user interface object, a transparency parameter for controlling the transparency of the user interface object, an orientation parameter for controlling an orientation of the user interface object, and a color parameter for controlling a color of the user interface object. A parameter may be bound to one or more virtual variables, so that the parameter changes as the value of the virtual variable changes. As an example, a size parameter of a user interface object may be set to increase as a virtual puck approaches the user interface object. As such, that user interface object may zoom in and out as a function of the position of the virtual puck.

The mapping instructions from a virtual variable to a changeable parameter of a interface object can be expressed in a simpler form than a general purpose programming language to gain both higher performance and lower risk to the kernel of the graphics engine. In particular, the mapping functions may be stateless so that all state in the user interface control are confined to a finite number of hard coded physics engines. Stateless mapping functions may offer a number of favorable qualities that are not offered by general purpose code. For example, stateless mapping functions may be easier to create in a graphical user interface authoring tool; stateless mapping functions may be more easily optimized for execution on a target platform; and/or the execution time of a stateless function may be more easily bounded to preserve a reasonable display frame rate.

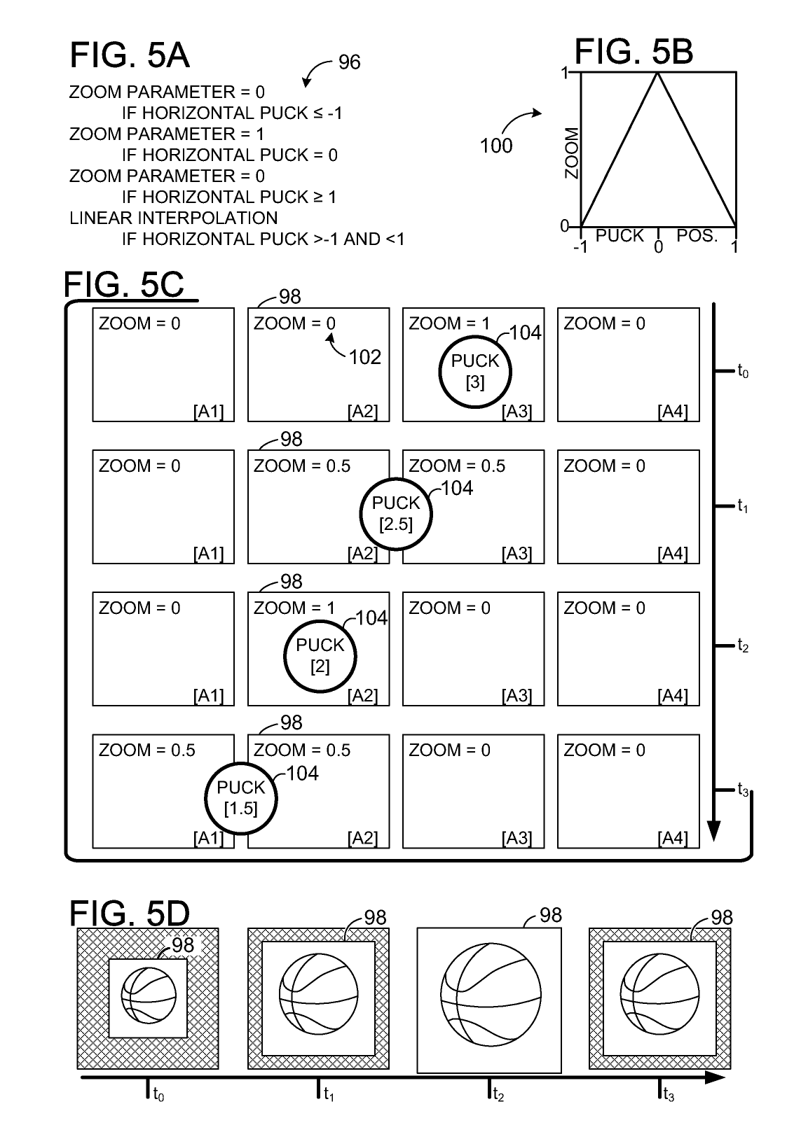

FIG. 5A shows example parameter data 96 in a generic form. It is to be understood that parameter data, and/or other aspects of non-executable data, may be written with a variety of different forms, languages, and/or syntaxes without departing from the scope of this disclosure. For example, as introduced above, non-executable data may take the form of XML data. The generic parameter data shown in FIG. 5A is intended to demonstrate concepts compatible with the disclosed data driven method of animating a user interface without limiting the disclosure to the form or syntax of example parameter data 96. For simplicity, example parameter data is bound to a single virtual variable—namely the horizontal position of a virtual puck. It is to be understood that parameter data may be bound to two or more different virtual variables without departing from the scope of this disclosure.

Parameter data 96 specifies a first display value of a changeable display parameter corresponding to a first virtual position of the virtual puck. In the illustrated example, the display value for a zoom parameter is specified as being “0” when the horizontal position of the virtual puck is less than the horizontal position of the user interface object to which the parameter data applies by one or more. As an example, consider a digital photograph 98 of FIGS. 5C and 5D. Digital photograph 98 is located at a cell position A2. According to parameter data 96, the display value for the zoom parameter of digital photograph 98 is to be set at “0” when the virtual puck is at cell position A1 (or less). Likewise, the display value for the zoom parameter is specified as being “0” when the horizontal position of the virtual puck is more than the horizontal position of the user interface object by one or more. As an example, still considering digital photograph 98 located at cell position A2—according to parameter data 96, the display value for the zoom parameter is to be set at “0” when the virtual puck is at cell position A3 (or more). Continuing with this example, the display value for the zoom parameter is specified as being “1” when the horizontal position of the virtual puck is equal to the horizontal position of the user interface object. As such, the zoom parameter for digital photograph 98 at cell position A2 is to be set at “1” when the virtual puck is at cell position A2. The parameter data 96 further specifies that a linear interpolation is to be used between the given values. FIG. 5B shows a plot 100 that graphically represents the specifications of parameter data 96. It is to be understood that virtually any interpolation may be used without departing from the scope of this disclosure.

FIGS. 5C and 5D show a time sequence that illustrates how a display value (e.g., zoom value 102) of a changeable parameter (e.g., a zoom parameter of digital photograph 98) changes responsive to movement of a virtual puck 104 in accordance with the specifications of parameter data 96. As shown in FIG. 5C, at time t₀, virtual puck 104 is located at cell A3. Digital photograph 98, which is schematically shown in FIG. 5C, is located at cell A2. As such, at time t₀ the virtual puck is horizontally offset from the digital photograph by [+1.0]. Parameter data 96 specifies that such an offset results in a zoom value of zero. As such, FIG. 5D shows digital photograph 98 unzoomed at time tₒ.

Returning to FIG. 5C, at time t₁, virtual puck 104 is located between cell A2 and cell A3. In particular, virtual puck 104 has a horizontal coordinate virtual variable value of [2.5]. Digital photograph 98 is located at cell A2, which corresponds to a horizontal value of [2.0]. As such, at time t₁ the virtual puck is horizontally offset from the digital photograph by [+0.5]. Parameter data 96 specifies that such an offset results in a zoom value of [+0.5]. As such, FIG. 5D shows digital photograph 98 with a 50% zoom at time t₁.

Returning to FIG. 5C, at time t₂, virtual puck 104 is located at cell A2. In particular, virtual puck 104 has a horizontal coordinate virtual variable value of [2.0]. Digital photograph 98 is located at cell A2, which corresponds to a horizontal value of [2.0]. As such, at time t₂ the virtual puck is not horizontally offset from the digital photograph. In other words, the horizontal offset is [0.0]. Parameter data 96 specifies that such an offset results in a zoom value of [+1.0]. As such, FIG. 5D shows digital photograph 98 with a 100% zoom at time t₂.

Returning to FIG. 5C, at time t₃, virtual puck 104 is located between cell A1 and cell A2. In particular, virtual puck 104 has a horizontal coordinate virtual variable value of [1.5]. Digital photograph 98 is located at cell A2, which corresponds to a horizontal value of [2.0]. As such, at time t₃ the virtual puck is horizontally offset from the digital photograph by [−0.5]. Parameter data 96 specifies that such an offset results in a zoom value of [+0.5]. As such, FIG. 5D shows digital photograph 98 with a 50% zoom at time t₃.

As can be seen by way of the above example, digital photograph 98 zooms and unzooms as a function of the position of the virtual puck. As described above, the logic and processing for controlling the virtual puck can be managed by the user-input engine 50 and the physics engine(s) 52. A content provider need not provide any input and/or instructions with respect to how the virtual puck moves in response to user input. Instead, a content provider can focus on how user interface objects are to visually change in response to movement of the virtual puck.

While parameter data 96 only specifies three display values at three corresponding horizontal positions of the virtual puck, a relative zoom can be determined for any horizontal position of the virtual puck. Moreover, virtual variables other than horizontal puck position may be considered. As an example, a zoom may only be applied to user interface objects within a specified tolerance of the vertical position of the virtual puck. The horizontal puck position, vertical puck position, and/or other virtual variables may be calculated using different physics engines.

While the example of FIGS. 5A-5D provides a zoom parameter of a digital photograph as an example, it is to be understood that the above described ideas may be expanded to different user interface objects and/or different parameters of the same user interface object. As a nonlimiting example, FIG. 1 shows an example where a virtual puck (not shown) is located at cell A2. As such, a user interface object in the form of digital photograph 98 is zoomed to 100%, while adjacent photographs are partially zoomed and other digital photographs remain unzoomed. Such a zoom arrangement may be established by parameter data in which a zoom parameter is set at 0% when a virtual puck is two or more spaces away from a photograph, and a zoom parameter is set at 100% when the virtual puck is at the same space as the photograph.

Furthermore, a user interface object in the form of title 42 is displayed with 100% opacity, while titles associated with other cells are not displayed (i.e., displayed with 0% opacity). As another example, a user interface object in the form of a background rectangle 44 is displayed with a solid fill, while background rectangles associated with other cells are displayed with a cross-hatched fill. As a final example, a user interface object in the form of a cursor is displayed surrounding cell A2. Such a user interface object may be configured to track movement of a virtual puck.

Parameter data, as described above, allows a content provider to specify sophisticated display behaviors for various user interface objects without having to write complicated programs and/or scripts. To the contrary, content providers may instead specify selected display values as a stateless function of a virtual variable and a type of interpolation to use between the selected display values. In this way, content provider can design robust and visually stimulating user interfaces, which may be defined using easy-to-write, non-executable data.

In some embodiments, the non-executable, user interface data may include template data defining how equivalent parameters of a plurality of different user interface objects are to be displayed by a cloud computing device as a stateless function of one or more virtual variables. As an example, parameter data, such as parameter data 96 of FIG. 5A, may be specified for a zoom parameter of all digital photographs in a list of digital photographs. In this way, parameter data 96 may be used for all digital photographs in the list, not just digital photograph 98 at cell A2.

Returning to FIG. 2, display engine 56 may be configured to dynamically change an appearance of one or more of the plurality of user interface objects as a stateless function of the virtual position of the virtual puck. In other words, after the user-input engine 50 and the physics engine(s) 52 cooperate to find the display values of the various parameters of the user interface objects, the display engine may generate a display signal that can be used by a display to present a corresponding display image—for example, display image 23 of FIG. 1 showing a photo browser including a zoomed digital photograph 98. The display engine may output display instructions for displaying the changeable display parameters of one or more user interface objects with display values interpolated from parameter data as a stateless function of one or more virtual variables (e.g. horizontal puck position).

Furthermore, as introduced above, the display engine may be configured to choose which user interface objects to display as a stateless function of the virtual position of a virtual frame. As discussed with reference to FIGS. 3 and 4, a virtual position of a virtual frame may be updated in response to updates made to the value of a virtual variable. The user interface objects that are to be displayed may be chosen as a stateless function of the virtual position of the virtual frame. As an example, user interface objects in cells A1, A2, A3, A4, B1, B2, B3, and B4 may be displayed at time t₀ of FIG. 3 because virtual frame 90 surrounds those cells at that time. As another example, user interface objects in cells S1, S2, S3, S4, T1, T2, T3, and T4 may be displayed at time t2 of FIG. 4 because virtual frame 90 surrounds those cells at that time.

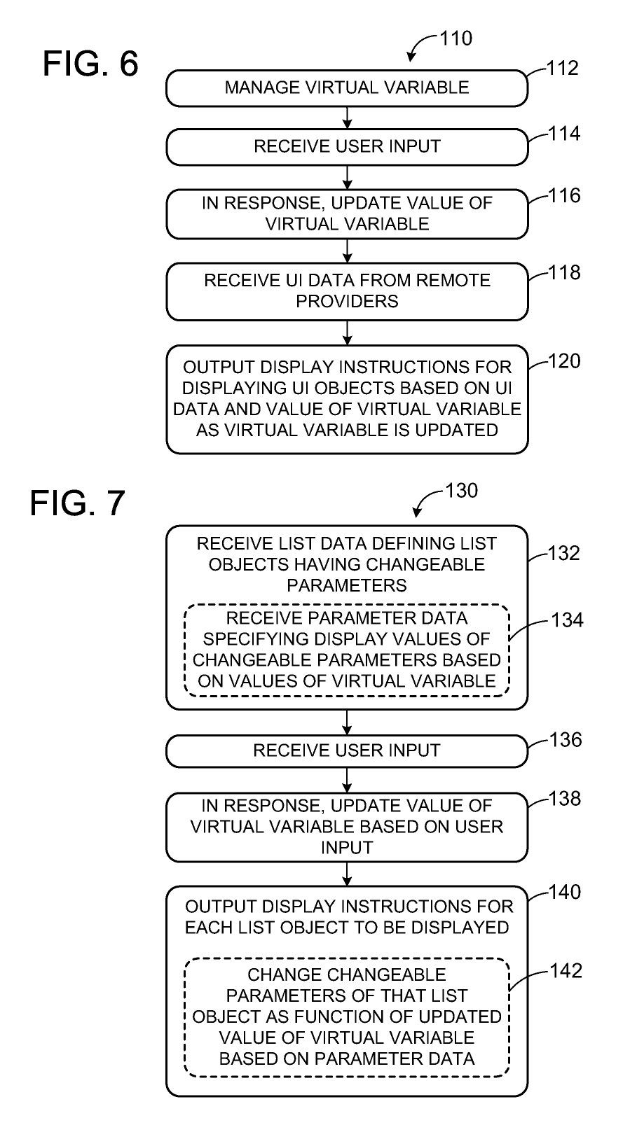

FIG. 6 shows an example data driven method 110 of animating a user interface in accordance with the present disclosure. At 112, method 110 includes managing a virtual variable with a cloud computing device. At 114, method 110 includes receiving user input at the cloud computing device. In response to receiving such user input, at 116 method 110 includes using a physics engine of the cloud computing device to update a value of the virtual variable. At 118, method 110 includes receiving UI data at the cloud computing device from one or more remote content providers. Such UI data may define one or more user interface objects and how the user interface objects are to be displayed by the cloud computing device as a stateless function of the virtual variable. At 120, method 110 includes outputting display instructions for displaying the user interface objects in accordance with the UI data and the value of the virtual variable as the value of the virtual variable is updated by the physics engine.

FIG. 7 shows an example method 130 of animating a list in accordance with the present disclosure. At 132, method 130 includes receiving list data defining a plurality of list objects having one or more changeable parameters. Each list object may include parameter data for each of the changeable parameters, wherein the parameter data specifies display values of the changeable parameters based on values of the virtual variable, as indicated at 134. For example, parameter data may specify a first display value of the changeable parameter at a first boundary value of a virtual variable and a second display value of the changeable parameter at a second boundary value of the virtual variable. The parameter data may also specify an interpolation for finding display values of that changeable parameter at values of the virtual variable that are between the first boundary value of the virtual variable and the second boundary value of the virtual variable.

At 136, method 130 includes receiving user input. In response, at 138, method 130 includes updating a value of the virtual variable in accordance with the user input. At 140, method 130 includes, for each list object to be displayed, outputting display instructions for displaying that list object. The display instructions may be formulated such that each of the changeable parameters for that list object changes as a stateless function of the updated value of the virtual variable as specified by the parameter data for that changeable parameter, as indicated at 142.

In some embodiments, the above described methods and processes may be tied to a computing system such as a cloud computing device. As an example, FIG. 2 schematically shows a cloud computing device 20 that may perform one or more of the above described methods and processes. Cloud computing device 20 includes a logic subsystem 57 and a data-holding subsystem 58. Cloud computing device 20 may optionally include a display subsystem and/or other components not shown in FIG. 2.

Logic subsystem 57 may include one or more physical devices configured to execute one or more instructions. For example, the logic subsystem may be configured to execute one or more instructions that are part of one or more programs, routines, objects, components, data structures, or other logical constructs. Such instructions may be implemented to perform a task, implement a data type, transform the state of one or more devices, or otherwise arrive at a desired result. The logic subsystem may include one or more processors that are configured to execute software instructions. Additionally or alternatively, the logic subsystem may include one or more hardware or firmware logic machines configured to execute hardware or firmware instructions. The logic subsystem may optionally include individual components that are distributed throughout two or more devices, which may be remotely located in some embodiments.

Data-holding subsystem 58 may include one or more physical devices configured to hold data and/or instructions executable by the logic subsystem to implement the herein described methods and processes. When such methods and processes are implemented, the state of data-holding subsystem 58 may be transformed (e.g., to hold different data). Data-holding subsystem 58 may include removable media and/or built-in devices. Data-holding subsystem 58 may include optical memory devices, semiconductor memory devices, and/or magnetic memory devices, among others. Data-holding subsystem 58 may include devices with one or more of the following characteristics: volatile, nonvolatile, dynamic, static, read/write, read-only, random access, sequential access, location addressable, file addressable, and content addressable. In some embodiments, logic subsystem 57 and data-holding subsystem 58 may be integrated into one or more common devices, such as an application specific integrated circuit or a system on a chip.

In some embodiments, the data-holding subsystem may be in the form of computer-readable removable media, which may be used to store and/or transfer data and/or instructions executable to implement the herein described methods and processes.

The term “engine” may be used to describe an aspect of cloud computing device 20 that is implemented to perform one or more particular functions. In some cases, such an engine may be instantiated via logic subsystem 57 executing instructions held by data-holding subsystem 58. It is to be understood that different engines may be instantiated from the same application, code block, object, routine, and/or function. Likewise, the same module and/or engine may be instantiated by different applications, code blocks, objects, routines, and/or functions in some cases. Also, such an engine may include other hardware components for performing the relevant functions.

When included, a display subsystem, such as high definition television 24, may be used to present a visual representation of data held by data-holding subsystem 58. As the herein described methods and processes change the data held by the data-holding subsystem, and thus transform the state of the data-holding subsystem, the state of display subsystem may likewise be transformed to visually represent changes in the underlying data. Display subsystem may include one or more display devices utilizing virtually any type of technology. Such display devices may be combined with logic subsystem 57 and/or data-holding subsystem 58 in a shared enclosure, or such display devices may be peripheral display devices.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A cloud computing device, comprising:
a user-input engine to receive user interface control commands from a user input device;
a physics engine to dynamically update a virtual position of a virtual puck responsive to user interface control commands received via the user-input engine;
a communication engine to receive non-executable data from one or more content providers via one or more networks, the non-executable data defining a plurality of user interface objects and how the plurality of user interface objects are to be displayed as a function of the virtual position of the virtual puck; and
a display engine to dynamically change an appearance of one or more of the plurality of user interface objects as a function of the virtual position of the virtual puck.

2. The cloud computing device of claim 1, where the physics engine is configured to interrupt an unfinished update of the virtual position of the virtual puck if a subsequent user interface control command is received during the unfinished update, and where the physics engine is configured to update the virtual position of the virtual puck responsive to the subsequent user interface control command.

3. The cloud computing device of claim 1, where the physics engine is configured to dynamically update the virtual position of the virtual puck using physics-based dynamics that consider virtual puck position and virtual puck velocity.

4. The cloud computing device of claim 1, where the non-executable data includes parameter data for at least a first user interface object, the parameter data specifying a first display value of a changeable display parameter corresponding to a first virtual position of the virtual puck; a second display value of the changeable display parameter corresponding to a second virtual position of the virtual puck; and an interpolation for finding display values of that changeable display parameter corresponding to virtual positions of the virtual puck that are between the first virtual position of the virtual puck and the second virtual position of the virtual puck.

5. The cloud computing device of claim 4, where the parameter data is template data useable to find display values for equivalent parameters of a plurality of different user interface objects.

6. The cloud computing device of claim 1, where the physics engine is configured to dynamically update a virtual position of a virtual frame responsive to the virtual position of the virtual puck, and where the display engine is configured to choose which user interface objects to display as a function of the virtual position of the virtual frame.

7. The cloud computing device of claim 1, where the user input device is a remote control.

8. The cloud computing device of claim 1, where the non-executable data is XML data and the cloud computing device further comprises an XML processing engine to translate the XML data for use by the physics engine and the display engine.

9. A data driven method of animating a user interface, the method comprising:
managing a virtual variable with a cloud computing device;
in response to receiving user input at the cloud computing device, using a physics engine of the cloud computing device to update a value of the virtual variable;
receiving UI data at the cloud computing device from one or more remote content providers, the UI data defining one or more user interface objects and how the one or more user interface objects are to be displayed by the cloud computing device as a stateless function of the virtual variable; and
outputting display instructions for displaying the one or more user interface objects in accordance with the UI data and the value of the virtual variable as the value of the virtual variable is updated by the physics engine.

10. The method of claim 9, where the UI data includes parameter data for at least a first user interface object, the parameter data specifying a first display value of a changeable display parameter corresponding to a first value of the virtual variable; a second display value of the changeable display parameter corresponding to a second value of the virtual variable; and an interpolation for finding display values of that changeable display parameter corresponding to virtual values of the virtual variable that are between the first value of the virtual variable and the second value of the virtual variable.

11. The method of claim 10, where outputting display instructions for displaying the one or more user interface objects includes outputting display instructions for displaying the changeable display parameter of the first user interface object with a display value interpolated from the parameter data as a function of the virtual variable.

12. The method of claim 9, where the virtual variable is a horizontal screen coordinate of a virtual puck.

13. The method of claim 9, where the virtual variable is a vertical screen coordinate of a virtual puck.

14. The method of claim 9, further comprising:
interrupting an unfinished update of the value of the virtual variable if a subsequent user input is received during the unfinished update; and
updating the virtual value of the virtual variable responsive to the subsequent user input.

15. The method of claim 9, where the value of the virtual variable is updated by the physics engine using physics-based dynamics that consider a starting value of the virtual variable and a time derivative of the virtual variable.

16. The method of claim 9, further comprising, in response to updating the value of the virtual variable, updating a virtual position of a virtual frame and choosing which user interface objects to display as a function of the virtual position of the virtual frame.

17. The method of claim 9, where the UI data includes template data defining how equivalent parameters of a plurality of different user interface objects are to be displayed by the cloud computing device as a function of the virtual variable.

18. A method of animating a list, the method comprising:
receiving list data defining a plurality of list objects having one or more changeable parameters, each list object including parameter data for each of the one or more changeable parameters, such parameter data specifying:
a first display value of the changeable parameter at a first boundary value of a virtual variable,
a second display value of the changeable parameter at a second boundary value of the virtual variable; and
an interpolation for finding display values of that changeable parameter at values of the virtual variable that are between the first boundary value of the virtual variable and the second boundary value of the virtual variable;
in response to receiving user input, updating a value of the virtual variable in accordance with the user input; and
for each list object to be displayed, outputting display instructions for displaying that list object such that each of the one or more changeable parameters for that list object changes as a stateless function of the updated value of the virtual variable as specified by the parameter data for that changeable parameter.

19. The method of claim 18, where the value of the virtual variable is updated in accordance with the user input, an input-time value of the virtual variable, and an input-time first derivative of the virtual variable.

20. The method of claim 18, where the parameter data is template data useable to find display values for equivalent parameters of a plurality of different list objects.
